(19) United States
(12) Patent Application Publication
(10) Pub. No.: US 2021/0078391 A1
(43) Pub. Date: Mar. 18, 2021

(54) VEHICLE OPENING-CLOSING STRUCTURE

(71) Applicant: KABUSHIKI KAISHA TOYOTA JIDOSHOKKI, Aichi (JP)

(72) Inventors: Hirofumi ARIMA, Aichi (JP); Hideaki TERAI, Aichi (JP)

(73) Assignee: KABUSHIKI KAISHA TOYOTA JIDOSHOKKI, Aichi (JP)

(21) Appl. No.: 16/954,009

(22) PCT Filed: Dec. 19, 2018
(86) PCT No.: PCT/JP2018/046844

§ 371 Date: Jun. 15, 2020

(30) Foreign Application Priority Data
Dec. 21, 2017 (JP) 2017-245062

(51) Int. Cl. B60J 5/14; B60J 5/10; E05F 11/54

(52) U.S. Cl. CPC B60J 5/14; B60J 5/107; E05Y 2900/548; E05Y 2201/684; E05F 11/54

(57) ABSTRACT

A vehicle opening-closing structure includes: a pair of guide rails disposed to extend on both sides of an opening provided in a vehicle; and an opening-closing member that is slidably guided by the pair of guide rails and opens and closes the opening. The opening-closing member has a plurality of panel portions arranged along an extending direction of the guide rail, and a soft portion integrally provided with the panel portion to be disposed between the panel portion and the plurality of panel portions, and is formed of a soft resin softer than a material that forms the panel portion.

### TECHNICAL FIELD

The present disclosure relates to a vehicle opening-closing structure.

### BACKGROUND ART

As a vehicle opening-closing structure of the related art, for example, a technique described in Patent Literature 1 is known. The vehicle opening-closing structure described in Patent Literature 1 includes a shutter block. The shutter block has a plurality of shutter plates connected to each other along a shutter moving direction. The shutter plate is made of a high-tensile steel material or a hard resin. The shutter plate is movable along a rail close to a window frame.

### CITATION LIST

### Patent Literature

[Patent Literature 1] Japanese Unexamined Patent Publication No. 2006-219086

### SUMMARY OF INVENTION

### Technical Problem

However, the technique of the related art has the following problems. In other words, depending on the shape of the vehicle, there is a case where the shutter block which is an opening-closing member moves up and down while bending. In this case, a connecting portion of each shutter plate is bent when the shutter block moves up and down. When the connecting portion of each shutter plate is bent in this manner, it becomes difficult to ensure the sealing properties of the shutter block.

An object of the present disclosure is to provide a vehicle opening-closing structure that can ensure the sealing properties of an opening-closing member regardless of the shape of a vehicle.

### Solution to Problem

According to an aspect of the present disclosure, there is provided a vehicle opening-closing structure including: a pair of guide rails disposed to extend on both sides of an opening provided in a vehicle; and an opening-closing member that is slidably guided by the pair of guide rails and opens and closes the opening, in which the opening-closing member has a plurality of panel portions arranged along an extending direction of the guide rail, and a soft portion integrally provided with the panel portion to be disposed between the panel portion and the panel portion, and in which the soft portion is formed of a soft resin softer than a material that forms the panel portion.

In the vehicle opening-closing structure according to an aspect of the present disclosure, by sliding the opening-closing member with respect to the pair of guide rails disposed to extend on both sides of the opening provided in the vehicle, the opening-closing member opens and closes the opening. The opening-closing member has the plurality of panel portions arranged along the extending direction of the guide rail, and the soft portion integrally provided with the panel portion to be disposed between the panel portion and the panel portion. In other words, the opening-closing member has a structure in which the panel portion and the soft portion are alternately disposed along the extending direction of the guide rail. Therefore, for example, when the opening-closing member slides while bending in accordance with the shape of the vehicle, the soft portion formed of a soft resin softer than the material that forms the panel portion is elastically deformed and bent. Accordingly, regardless of the shape of the vehicle, the sealing properties of the opening-closing member are ensured.

In the embodiment, the soft portion may be formed in any one of a concave shape, a convex shape, and an uneven shape with respect to the panel portion. In this case, since a contact area between the panel portion and the soft portion increases, a peeling strength between the panel portion and the soft portion is improved.

In the embodiment, a thickness dimension of the soft portion may be smaller than a thickness dimension of the panel portion. In this case, when the soft portion is elastically deformed and bent, stress applied to the soft portion is reduced.

In the embodiment, the opening may be provided at a rear portion of the vehicle, and the pair of guide rails may extend along an up-down direction of the vehicle on both sides of the opening in a vehicle width direction. In this case, by moving the opening-closing member up and down with respect to the opening, the opening-closing member functions as a back door. Accordingly, the opening-closing member can be opened and closed even in a case where a space that exists behind the vehicle is narrow.

In the embodiment, a pair of roof rails may be provided on both sides in the vehicle width direction of a roof of the vehicle, the pair of guide rails may further extend on both sides of the roof in the vehicle width direction, and the pair of roof rails may form a part of the pair of guide rails. In this case, when the opening-closing member moves up and down with respect to the opening, the opening-closing member slides in the up-down direction along the guide rail at the rear portion of the vehicle, and the opening-closing member slides in a front-rear direction on an upper side of the roof along the roof rail (guide rail). Therefore, when the opening-closing member opens the opening, the opening-closing member is positioned on an outer side the roof, and thus, the opening-closing member can be held without narrowing the space in a vehicle compartment.

In the embodiment, a material that forms the panel portion may be a resin. In this case, a weight of the opening-closing member can be reduced.

In the embodiment, the resin may be a transparent resin. In this case, the panel portion can function as a window.

### Advantageous Effects of Invention

According to the present disclosure, it is possible to ensure the sealing properties of the opening-closing member regardless of the shape of the vehicle.

### BRIEF DESCRIPTION OF DRAWINGS

FIG. 1 is a perspective view illustrating a rear part of a vehicle provided with a vehicle opening-closing structure according to an embodiment of the present disclosure.

FIG. 2 is a sectional view illustrating the rear part of the vehicle illustrated in FIG. 1.

FIG. 3 is a perspective view illustrating a state where a back door is open at the rear part of the vehicle illustrated in FIG. 1.

FIG. 4 is an enlarged sectional view of a part A illustrated in FIG. 2.

FIG. 5 is an enlarged sectional view of a part B illustrated in FIG. 1.

FIG. 6 is an enlarged sectional view of a part C illustrated in FIG. 3.

FIG. 7A is an enlarged sectional view illustrating a modification example of the back door illustrated in FIG. 4.

FIG. 7B is an enlarged sectional view illustrating another modification example of the back door illustrated in FIG. 4.

FIG. 7C is an enlarged sectional view illustrating another modification example of the back door illustrated in FIG. 4.

### DESCRIPTION OF EMBODIMENTS

Hereinafter, embodiments of the present disclosure will be described with reference to the drawings. In addition, in the drawings, the same or equivalent elements will be given the same reference numerals, and the redundant description thereof will be omitted.

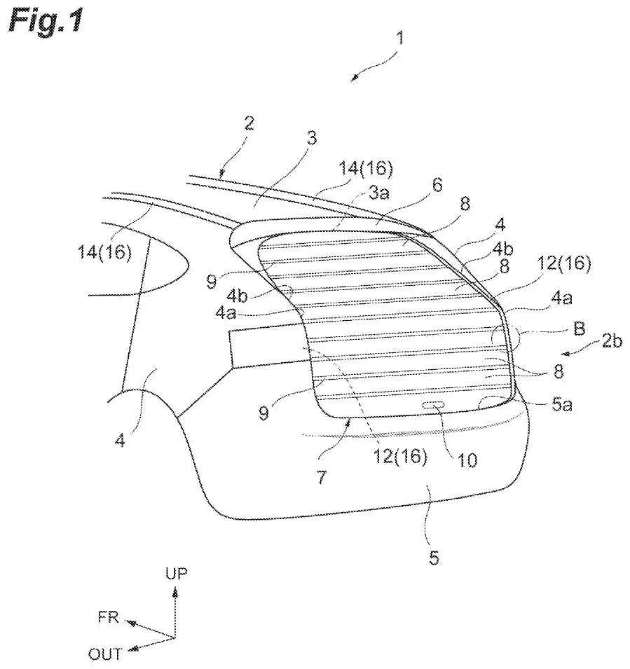

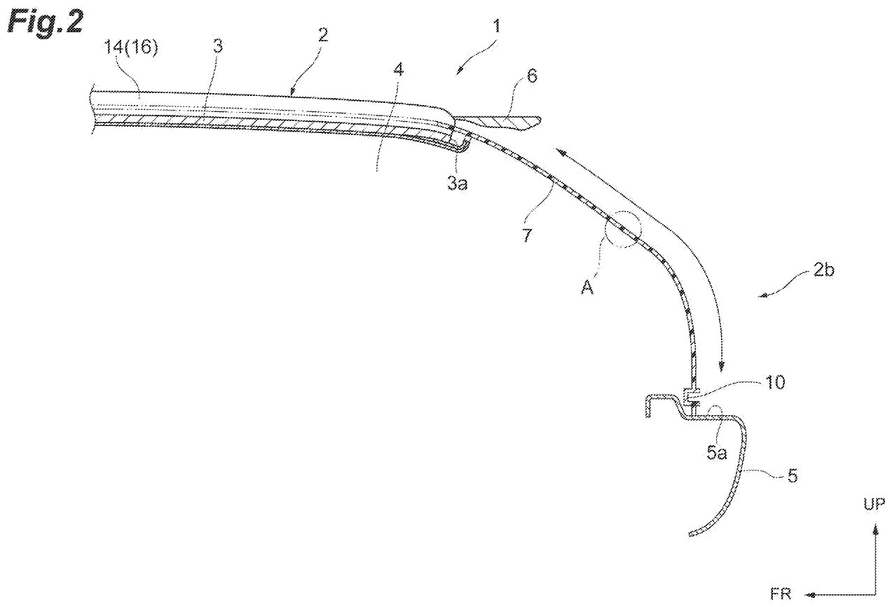

FIG. 1 is a perspective view illustrating a rear part of a vehicle provided with a vehicle opening-closing structure according to an embodiment of the present disclosure. FIG. 2 is a sectional view illustrating the rear part of the vehicle illustrated in FIG. 1. In FIGS. 1 and 2, a vehicle 1 includes a vehicle body 2. An arrow FR in the drawing indicates a front side of the vehicle body 2 in a front-rear direction, an arrow UP in the drawing indicates an upper side in an up-down direction of the vehicle body 2, and an arrow OUT in the drawing indicates an outer side (left side in a left-right direction) in a vehicle width direction of the vehicle body 2.

The vehicle body 2 has a roof panel 3 (roof) and a pair of side panels 4 disposed on both left and right sides of the roof panel 3. The roof panel 3 is provided at the upper part of the vehicle body 2. The side panel 4 is provided at a side portion of the vehicle body 2. A bumper 5 is provided at a lower rear end portion of the vehicle body 2. A spoiler 6 is provided at an upper rear end portion of the vehicle body 2.

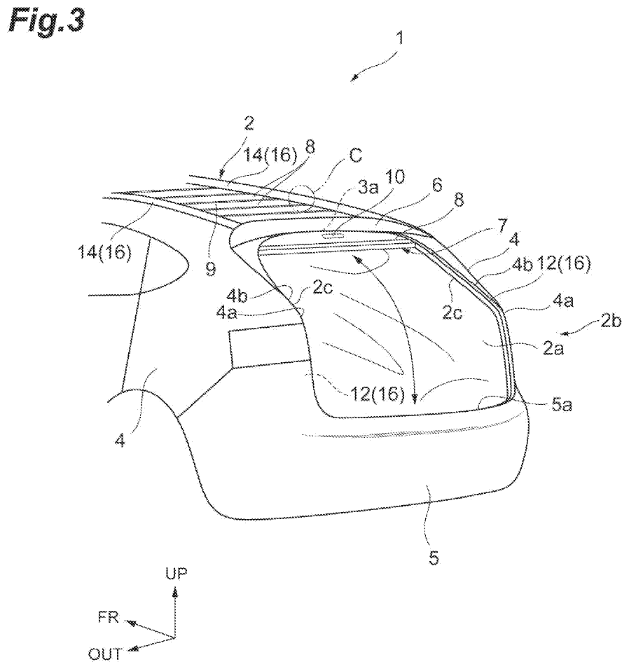

An opening 2a is provided at a rear end portion 2b (rear portion) of the vehicle body 2, as illustrated in FIG. 3. The opening 2a is defined by, for example, a rear end 3a of the roof panel 3, a rear end 4b of the pair of side panels 4, and an upper end 5a of the bumper 5. A curved portion 4a is provided at the rear end 4b of the side panel 4 that forms the opening 2a. A side edge (hereinafter, an upper edge portion 2c of the opening 2a) of a region at the upper part of the curved portion 4a in the opening 2a has a shape that bends toward the front side of the vehicle body 2.

Further, as illustrated in FIGS. 1 to 3, the vehicle 1 includes an openable-closable back door 7 that covers the opening 2a of the rear end portion 2b of the vehicle body 2. The back door 7 is an opening-closing member that can move up and down with respect to the opening 2a. In addition, FIGS. 1 and 2 illustrate a state where the back door 7 is closed, and FIG. 3 illustrates a state where the back door 7 is open. In the following description, the opening-closing direction (hereinafter, the opening-closing direction of the back door 7) with respect to the back door 7 is a direction of an operation of opening and closing the back door 7 (refer to FIG. 3).

The back door 7 has a plurality of panel portions 8 arranged along the opening-closing direction of the back door 7, and a plurality of soft portions 9 integrally provided with the panel portion 8 to be disposed between the panel portion 8 and the panel portion 8 which are adjacent to each other. In other words, the back door 7 has a structure in which the panel portion 8 and the soft portion 9 are alternately disposed along the opening-closing direction of the back door 7. The panel portion 8 and the soft portion 9 extend with the vehicle width direction as a longitudinal direction. The panel portions 8 are disposed at both ends of the back door 7 in the opening-closing direction. A handle 10 for opening and closing the back door 7 is provided on the panel portion 8 positioned at the lower end of the back door 7.

The panel portion 8 is formed of a transparent resin. Examples of the transparent resin include poly carbonate and acrylic resin. The soft portion 9 is formed of a soft resin softer than the transparent resin that is a material that forms the panel portion 8. Examples of the soft resin include an elastomer and the like. The soft portion 9 is more easily elastically deformed than the panel portion 8.

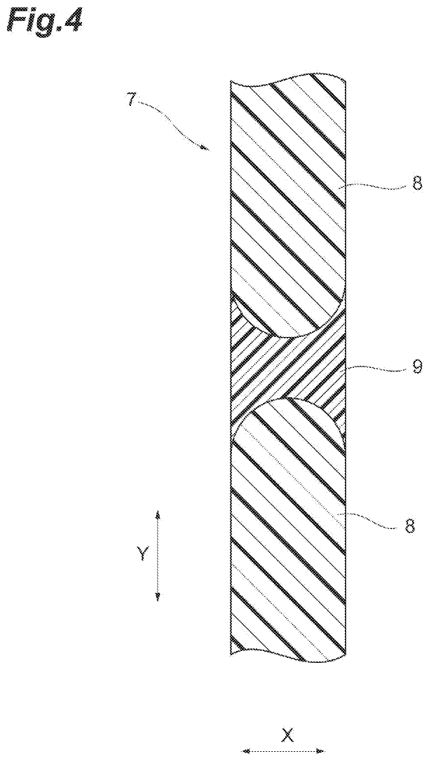

As illustrated in FIG. 4, the soft portion 9 is formed in a curved concave shape with respect to the panel portions 8 adjacent to each other on both sides when viewed from the vehicle width direction (a direction perpendicular to a thickness direction (X direction in FIG. 4) of the soft portion 9 and an arrangement direction (Y direction in FIG. 4) of the panel portions 8) of the vehicle body 2. Therefore, the height dimension of the soft portion 9 at both end portions in the thickness direction of the soft portion 9 is larger than the height dimension of the soft portion 9 at the center portion in the thickness direction of the soft portion 9. The height dimension of the soft portion 9 is a dimension along the arrangement direction (Y direction) of the panel portion 8. FIG. 4 is an enlarged sectional view of a part A in FIG. 2.

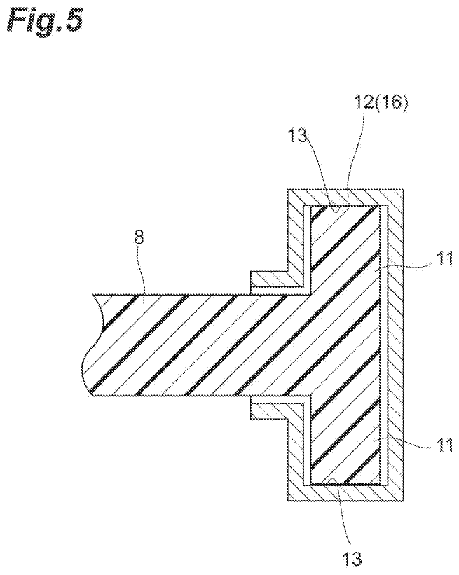

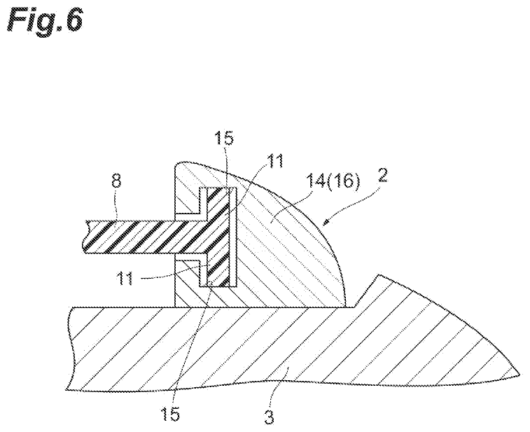

As illustrated in FIGS. 5 and 6, for example, two guide protrusion portions 11 that protrude in directions opposite to each other from the front surface and the back surface of the panel portion 8 are provided at each of both end portions of the panel portion 8 in the longitudinal direction. The guide protrusion portion 11 may be integrated with the panel portion 8.

In such a back door 7, the panel portion 8 and the soft portion 9 can be integrally molded by, for example, two-color molding. Specifically, after forming the panel portion 8 in a mold, the soft portion 9 is formed integrally with the panel portion 8 in another mold.

Up-down moving rails (guide rails) 12 for slidably guiding the back door 7 in the opening-closing direction of the back door 7 are attached to the rear ends 4b of each side panel 4, respectively. In other words, the vehicle 1 includes a pair of up-down moving rails 12 provided on both sides in the vehicle width direction at the rear portion of the vehicle body 2. The up-down moving rail 12 extends along the up-down direction of the vehicle body 2 on both sides of the opening 2a in the vehicle width direction. The lower portion of the up-down moving rail 12 extends in the up-down direction of the vehicle body 2. As described above, the upper edge portion 2c of the opening 2a has a shape that bends to the front side of the vehicle body 2. Therefore, the upper portion of the up-down moving rail 12 is bent to the front side of the vehicle body 2 in the up-down direction of the vehicle body 2 in accordance with the shape of the opening 2a. In the up-down moving rail 12, as illustrated in FIG. 5, a protrusion accommodating portion 13 which is engaged with the guide protrusion portion 11 of the back door 7 is formed. FIG. 5 is an enlarged sectional view of a part B in FIG. 1.

Roof rails (guide rails) 14 are respectively attached to the upper surfaces of both end portions of the roof panel 3 in the vehicle width direction. The roof rail 14 guides the back door 7 slidably in the front-rear direction of the vehicle body 2. In other words, the vehicle 1 includes a pair of roof rails 14 provided on both sides of the roof panel 3 in the vehicle width direction. The roof rail 14 extends in the front-rear direction of the vehicle body 2. The roof rail 14 is disposed continuously to the up-down moving rail 12. In addition, the roof rail 14 may be disposed at a slight interval from the up-down moving rail 12.

The pair of up-down moving rails 12 and the pair of roof rails 14 configure a pair of guide rails 16 disposed to extend on both sides of the opening 2a. The back door 7 is slidably guided by the pair of guide rails 16. Each panel portion 8 of the back door 7 is arranged along the extending direction of the guide rail 16.

In the roof rail 14, as illustrated in FIG. 6, a protrusion accommodating portion 15 which is engaged with the guide protrusion portion 11 of the back door 7 is formed. The roof rail 14 is disposed at a position where the rear end of the protrusion accommodating portion 15 formed on the roof rail 14 faces the front end of the protrusion accommodating portion 13 formed on the up-down moving rail 12. Therefore, the guide protrusion portion 11 of the back door 7 is movable over the protrusion accommodating portion 13 formed on the up-down moving rail 12 and the protrusion accommodating portion 15 formed on the roof rail 14. FIG. 6 is an enlarged sectional view of a part C in FIG. 3.

In the opening-closing structure of the vehicle 1 as described above, as illustrated in FIGS. 1 and 2, in a state where the back door 7 hits the bumper 5 and is fully closed, the back door 7 is locked to a frame (not illustrated) in the bumper 5 by a lock mechanism (not illustrated). In this state, when the lock between the back door 7 and the frame in the bumper 5 is released by an unlock lever (not illustrated) and the back door 7 is lifted with the handle 10, the guide protrusion portion 11 of the back door 7 slides to the upper side of the vehicle body 2 along the up-down moving rail 12. The guide protrusion portion 11 of the back door 7 slides to the front side of the vehicle body 2 along the roof rail 14. Accordingly, the back door 7 is open as illustrated in FIG. 3.

Here, the upper portion of the up-down moving rail 12 is bent to the front side of the vehicle body 2. Therefore, when the back door 7 is open, the guide protrusion portion 11 of the back door 7 slides while bending to the front side of the vehicle body 2 along the up-down moving rail 12. At this time, as the soft portion 9 of the back door 7 is elastically deformed and bent, the back door 7 bends along the up-down moving rail 12. When the back door 7 is open, the back door 7 is held in an open state by the sliding resistance between the guide protrusion portion 11 and the up-down moving rail 12.

When the back door 7 is lowered with the handle 10 from the state where the back door 7 is open, the guide protrusion portion 11 of the back door 7 slides to the lower side of the vehicle body 2 along the up-down moving rail 12. The guide protrusion portion 11 of the back door 7 slides to the rear side of the vehicle body 2 along the roof rail 14. Accordingly, the back door 7 is closed. In addition, when the back door 7 is fully closed, the back door 7 is locked to the frame (not illustrated) in the bumper 5 by the lock mechanism (not illustrated).

As described above, in the present embodiment, by sliding the back door 7 with respect to the pair of guide rails 16 disposed to extend on both sides of the opening 2a provided in the vehicle 1, the back door 7 opens and closes the opening 2a. The back door 7 has the plurality of panel portions 8 arranged along the extending direction of the guide rail 16, and the soft portion 9 integrally provided with the panel portion 8 to be disposed between the panel portion 8 and the panel portion 8. In other words, the back door 7 has a structure in which the panel portion 8 and the soft portion 9 are alternately disposed along the extending direction of the guide rail 16. Therefore, when the back door 7 slides while bending in accordance with the shape of the vehicle 1, the soft portion 9 formed of a soft resin softer than the material that forms the panel portion 8 is elastically deformed and bent. Accordingly, regardless of the shape of the vehicle 1, the sealing properties of the back door 7 can be ensured. In this manner, it becomes possible to set any trajectory of the up-down movement of the back door 7 in accordance with the shape of the vehicle 1 while ensuring the sealing properties of the back door 7.

In the present embodiment, the soft portion 9 is formed in a concave shape with respect to the panel portion 8. Accordingly, the contact area between the panel portion 8 and the soft portion 9 increases. Therefore, the peeling strength between the panel portion 8 and the soft portion 9 is improved.

In the present embodiment, by moving the back door 7 up and down with respect to the opening 2a, the back door 7 can be opened and closed even in a case where the space that exists behind the vehicle 1 is narrow.

In the present embodiment, when the back door 7 moves up and down with respect to the opening 2a, the back door 7 is guided by the up-down moving rail 12 (guide rail 16) to slide along the up-down direction of the vehicle body 2, and the back door 7 is guided by the roof rail 14 (guide rail 16) to slide on the upper side of the roof panel 3 along the front-rear direction of the vehicle body 2. Therefore, when the back door 7 opens the opening 2a, the back door 7 is positioned on the outer side of the roof panel 3, and thus, the back door 7 can be held without narrowing the space in the vehicle compartment.

In the present embodiment, since the panel portion 8 is formed of a transparent resin, the weight of the back door 7 can be reduced and the panel portion 8 can function as a window.

In addition, the present disclosure is not limited to the above-described embodiment. For example, in the above-described embodiment, as illustrated in FIG. 4, the soft portion 9 is formed in a curved concave shape with respect to the panel portion 8, but the shape of the soft portion 9 is not particularly limited thereto.

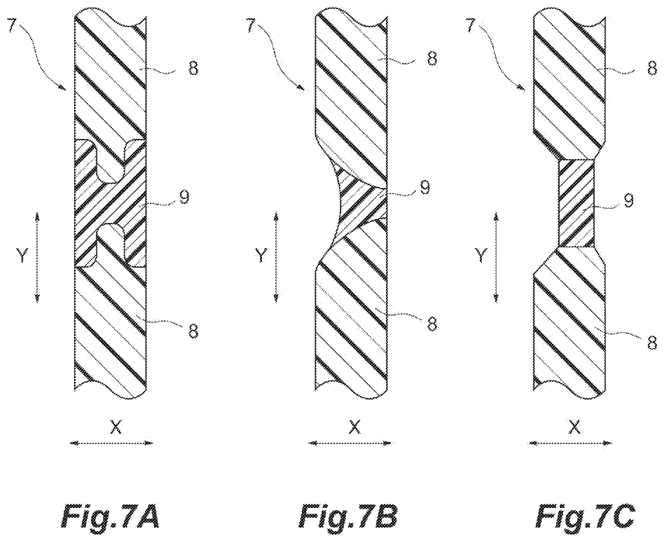

Specifically, FIGS. 7A, 7B, and 7C are enlarged sectional views illustrating modification examples of the back door 7 illustrated in FIG. 4. In the back door 7 illustrated in FIG. 7A, the soft portion 9 is formed in a substantially U-shaped concave shape with respect to the panel portions 8 adjacent to each other on both sides when viewed from the vehicle width direction of the vehicle body 2. In this case, the contact area between the panel portion 8 and the soft portion 9 further increases.

In FIGS. 4 and 7A, the soft portion 9 is formed in a concave shape with respect to the panel portion 8, but the shape is not particularly limited thereto, and the soft portion 9 may be formed in a convex shape with respect to the panel portion 8 when viewed from the vehicle width direction of the vehicle body 2, or the soft portion 9 may be formed in an uneven shape with respect to the panel portion 8 when viewed from the vehicle width direction of the vehicle body 2. In this case, the contact area between the panel portion 8 and the soft portion 9 can also be increased. Further, the shape of the soft portion 9 does not have to be any of a concave shape, a convex shape, and an uneven shape when viewed from the vehicle width direction of the vehicle body 2.

In the back door 7 illustrated in FIG. 7B, the thickness dimension of the soft portion 9 is smaller than the thickness dimension of the panel portion 8. At this time, the soft portion 9 may be disposed to one end side (here, the outside of the vehicle compartment) in the thickness direction with respect to the panel portion 8. In addition, the height dimension of the soft portion 9 may be gradually reduced from the inside of the vehicle compartment to the outside of the vehicle compartment. In such a configuration, since the thickness dimension of the soft portion 9 is smaller than the thickness dimension of the panel portion 8, the stress applied to the soft portion 9 when the soft portion 9 is elastically deformed and bent is reduced.

In the back door 7 illustrated in FIG. 7C, the thickness dimension of the soft portion 9 is smaller than the thickness dimension of the panel portion 8. At this time, the soft portion 9 may be disposed to be shifted to the outside of the vehicle compartment with respect to the panel portion 8. Further, the height dimension of the soft portion 9 may be entirely equal in the thickness direction of the soft portion 9. In such a configuration, since the thickness dimension of the soft portion 9 is smaller than the thickness dimension of the panel portion 8, the stress applied to the soft portion 9 when the soft portion 9 is elastically deformed and bent is also reduced.

In the above-described embodiment, when the back door 7 is opened, the back door 7 moves on the outer side (outside the vehicle compartment) of the roof panel 3 to the front side of the vehicle body 2 along the roof rail 14, but not being particularly limited thereto, the back door 7 may move to the front side of the vehicle body 2 between the roof panel 3 and the interior member (inside the vehicle compartment). The number and shape of the guide protrusion portions 11 are not limited to those of the above-described embodiment. The number and shape of the protrusion accommodating portions 13 and the shape of the protrusion accommodating portions 15 are not limited to those of the above-described embodiment.

In the above-described embodiment, the panel portion 8 is formed of a transparent resin, but the material for forming the panel portion 8 is not particularly limited thereto, and may be a resin other than the transparent resin, or may be a metal such as aluminum. Some of the plurality of panel portions 8 may be formed of a transparent resin, and the others of the plurality of panel portions 8 may be formed of a resin other than the transparent resin or a metal such as aluminum. Part of panel portion 8 may be formed of a transparent resin, and other parts may be formed of a resin other than the transparent resin or of a metal such as aluminum.

Further, the height dimension (dimension in the Y direction) of each panel portion 8 may not be particularly uniform. For example, the height dimension of the panel portion 8 that does not pass through the curved portion 4a provided at the rear end 4b of the side panel 4 may be larger than the height dimension of the panel portion 8 that passes through the curved portion 4a.

Further, in the above-described embodiment, the back door 7 can be moved up and down with respect to the opening 2a provided in the vehicle body 2, but the present disclosure is not particularly limited to the back door and can be applied to the side door. In addition, the present disclosure is also applicable to an opening-closing structure other than a door as long as the structure is installed on the vehicle. Furthermore, the present disclosure is not particularly limited to the opening-closing structure that slides in the up-down direction, and when it is possible to dispose the pair of guide rails so as to interpose the opening provided in the vehicle there-between, the present disclosure is applicable to the opening-closing structure that slides in the front-rear direction or in the left-right direction. The opening-closing member may not be necessarily slidably guided on all of the pair of guide rails. The opening-closing member may be slidably guided at least a part (for example, at the position of the curved portion 4a) of the pair of guide rails.

1 . . . vehicle

2a . . . opening

3 . . . roof panel (roof)

7 . . . back door (opening-closing member)

8 . . . panel portion

9 . . . soft portion

12 . . . up-down moving rail (guide rail)

14 . . . roof rail (guide rail)

16 . . . guide rail

1. A vehicle opening-closing structure comprising:
a pair of guide rails disposed to extend on both sides of an opening provided in a vehicle; and
an opening-closing member that is slidably guided by the pair of guide rails and opens and closes the opening,
wherein the opening-closing member has a plurality of panel portions arranged along an extending direction of the guide rail, and a soft portion integrally provided with the panel portion to be disposed between the panel portion and the panel portion, and
wherein the soft portion is formed of a soft resin softer than a material that forms the panel portion.

2. The vehicle opening-closing structure according to claim 1,
wherein the soft portion is formed in any one of a concave shape, a convex shape, and an uneven shape with respect to the panel portion.

3. The vehicle opening-closing structure according to claim 1,
wherein a thickness dimension of the soft portion is smaller than a thickness dimension of the panel portion.

4. The vehicle opening-closing structure according to claim 1,
wherein the opening is provided at a rear portion of the vehicle, and
wherein the pair of guide rails extend along an up-down direction of the vehicle on both sides of the opening in a vehicle width direction.

5. The vehicle opening-closing structure according to claim 4,
wherein a pair of roof rails are provided on both sides of a roof of the vehicle in the vehicle width direction,
wherein the pair of guide rails further extend on both sides of the roof in the vehicle width direction, and
wherein the roof rail forms a part of the guide rail.

6. The vehicle opening-closing structure according to claim 1,
wherein a material that forms the panel portion is a resin.

7. The vehicle opening-closing structure according to claim 6,
wherein the resin is a transparent resin.

8. The vehicle opening-closing structure according to claim 1,
wherein the panel portion and the soft portion are integrally molded.

9. The vehicle opening-closing structure according to claim 8,
wherein the panel portion and the soft portion are molded by two-color molding.
